(19) United States
(12) Patent Application Publication
(10) Pub. No.: US 2006/0244755 A1
(43) Pub. Date: Nov. 2, 2006

(54) Pre-rendering conversion of graphical data

(75) Inventors: Daniel F. Emerson, Redmond, WA (US); Feng Yue, Sammamish, WA (US); Khaled S. Sedky, Sammamish, WA (US); Oliver Foehr, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/116,473

(22) Filed: Apr. 28, 2005

(51) Int. Cl. G09G 5/00

(52) U.S. Cl. 345/581

(57) ABSTRACT

Pre-rendering conversion of graphical data can be provided within an image processing path. Om an example implementation, an image processing path includes an application, a graphics subsystem presenting a set of graphics primitives, and a device driver, which is associated with an imaging device. Computing system infrastructure is capable of detecting an incompatibility between the graphics subsystem and the device driver. When an incompatibility is detected, at least one conversion module is engaged to convert one or more graphics primitives in a first graphics subsystem-type format into one or more graphics primitives in a second driver-type format. The device driver can then render the one or more graphics primitives in the converted second driver-type format. A conversion module can be associated with, for example, the graphics subsystem or the device driver. Utilizing at least one conversion module can enable multiply graphics subsystem to interact with a single device driver.

### TECHNICAL FIELD

This disclosure relates in general to rendering images with a computing system and in particular, by way of example but not limitation, to enabling a transparent conversion of graphical data prior to rendering the image.

### BACKGROUND

Computing devices output images on multiple types of surfaces, such as display screens and printed paper. Each surface type may have images produced thereon using a different output device, such as a monitor or a printer. For computing devices to communicate and interoperate with such different output devices, the computing devices employ different device drivers. In this context, a given device driver is capable of driving an associated output device.

An application running on a computing device provides imaging commands to a device driver. The device driver in turn instructs an associated output device to produce the image. However, there are usually one or more infrastructure layers inserted between the application and the device driver to facilitate control, communication, and/or flexibility within the computing device.

One intervening layer that is typically inserted is a graphics layer, which is implemented by a graphics subsystem. The graphics subsystem presents or provides multiple graphics primitives and exposes them to the application as a set of application programming interfaces (APIs). The application can thus command the graphics subsystem using the provided graphics primitives. The graphics subsystem forwards the commands, after possible partial rendering, to the device driver for final and/or further rendering of the image.

Existing device drivers are designed to support a single developer platform and its associated graphics subsystem. Thus, each developer platform requires a separate device driver. Consequently, computing devices that offer two developer platforms must institute two separate image processing paths. As has been heretofore unappreciated, each image processing path therefore includes its own graphics subsystem and corresponding device driver that is designed to operate with a single graphics subsystem.

This situation is exacerbated as the number of developer platforms increases beyond two within a computing device. Moreover, there must be two or more device drivers for each device that is to communicate with two or more graphics subsystems. It can become increasingly undesirable and even infeasible to install, manage, and coordinate the multiplying number of device drivers. Accordingly, there is a need for schemes, mechanisms, techniques, etc. that can efficiently and/or transparently reduce the proliferation of multiple device drivers per output device in environments with multiple developer platforms.

### SUMMARY

Pre-rendering conversion of graphical data can be provided within an image processing path. In an example implementation, an image processing path includes an application, a graphics subsystem presenting a set of graphics primitives, and a device driver, which is associated with an imaging device. Infrastructure of a computing system is capable of detecting an incompatibility between the graphics subsystem and the device driver. When an incompatibility is detected, at least one conversion module is engaged to convert one or more graphics primitives in a first graphics subsystem-type format into one or more graphics primitives in a second driver-type format. The device driver can then render the one or more graphics primitives in the converted second driver-type format. A conversion module can be associated with, for example, the graphics subsystem or the device driver. Utilizing at least one conversion module can enable multiple graphics subsystems to interact with a single device driver.

Other method, system, approach, apparatus, device, media, procedure, API, arrangement, etc. implementations are described herein.

### BRIEF DESCRIPTION OF THE DRAWINGS

The same abbreviations and numbers are used throughout the drawings to reference like and/or corresponding aspects, features, and components.

FIG. 1 is a block diagram that illustrates an example image processing path with a pre-rendering conversion capability.

FIG. 2 is a block diagram that illustrates an example of multiple image processing paths that can utilize a single device driver, with each image processing path having a different graphics subsystem.

FIGS. 3A and 3B are example block diagrams illustrating a conversion module being associated with a graphics subsystem and with a device driver, respectively.

FIG. 4 is a flow diagram that illustrates an example of a method for a determination by general computing infrastructure if a conversion module is to be applied within an image processing path.

FIG. 5 is a flow diagram that illustrates an example of a method for a determination by a graphics subsystem if a conversion module is to be applied within an image processing path that includes the graphics subsystem.

FIG. 6 is a flow diagram that illustrates an example of a method for a determination by a device driver if a conversion module is to be applied within an image processing path that includes the device driver.

FIG. 7 is a block diagram of an example implementation of pre-rendering conversion when employing a new device driver with a legacy or a new application.

FIG. 8 is a block diagram of an example implementation of pre-rendering conversion when employing a legacy device driver with a legacy or a new application.

FIG. 9 illustrates an example of a computing (or general device) operating environment that is capable of (wholly or partially) implementing at least one aspect of pre-rendering conversion as described herein.

### DETAILED DESCRIPTION

### Introduction

Conventional device drivers are designed to support a single developer platform and its associated graphics subsystem. For example, with conventional printer drivers each developer platform requires a separate printer driver for each output device. With certain implementations that are described herein, however, schemes, mechanisms, techniques, etc. enable a single device driver having a rendering module to support two distinct graphics subsystems through the use of at least one conversion module.

More specifically, as described herein above, each device driver is usable with only a single graphics subsystem in conventional computing systems. As a consequence, for each device that is associated with a device driver, there is a device driver for each developer platform existing on a conventional computing system. If a conventional computing system has three developer platforms and four devices that require a device driver, then twelve different device drivers are involved to operate each of the four devices with any and all of the three developer platforms.

Fortunately, certain implementations as described herein can curb the proliferation of device drivers in multi-developer platform computing systems by utilizing one or more conversion modules. Continuing the hypothetical above for a described pre-rendering conversion implementation, the four devices may be operated with any or all of the three developer platforms with four device drivers and no more than six conversion modules. More specifically, with three graphics subsystems (e.g., G1, G2, and G3), six conversion modules (e.g., G1→G2, G1→G3, G2→G1, G2→G3, G3→G1, and G3→G2) can enable interoperability with the four devices.

In an example implementation, a conversion module is applied in an automatic manner such that the conversion is transparent to at least applications executing on the computing system as well as the end user. Image commands issued from an application are automatically converted, if necessary, prior to the image being rendered by a rendering module of a device driver. Each conversion module may be independent or may be associated with a graphics subsystem, a device driver, and so forth.

In a described implementation, infrastructure determines if graphics primitives corresponding to and targeted for a graphics subsystem fail to be compatible with a destination device driver. When an incompatibility is detected, a conversion module is applied to the graphics primitives in a first incompatible format to convert them into graphics primitives in a second compatible format. The graphics primitives that are in the second format, which is compatible with the destination device driver, are then provided to the device driver for rendering.

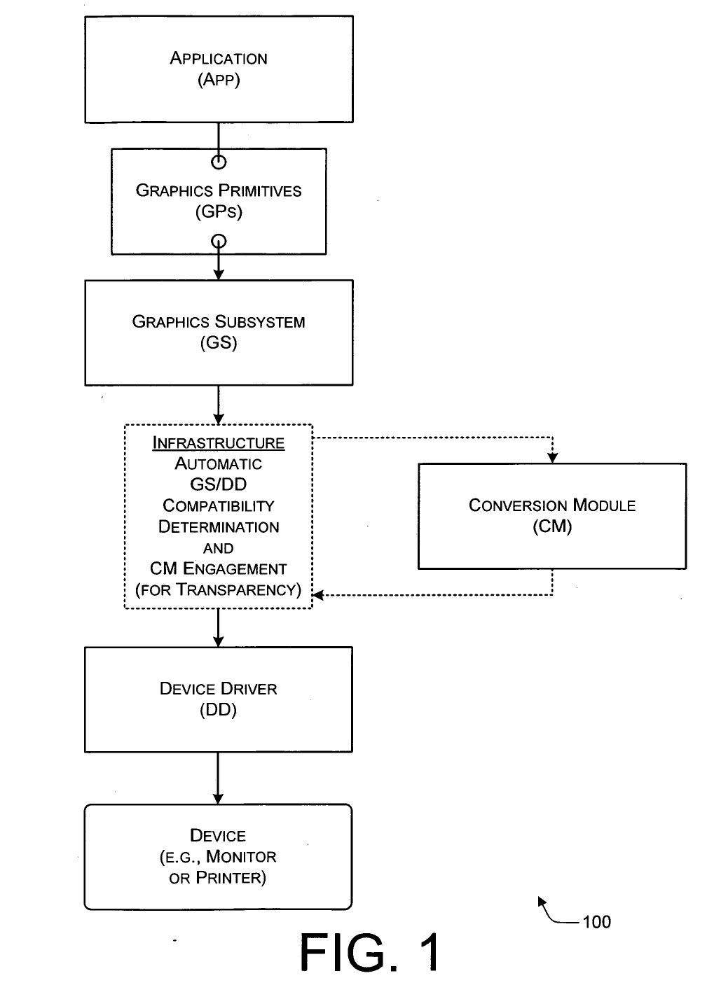

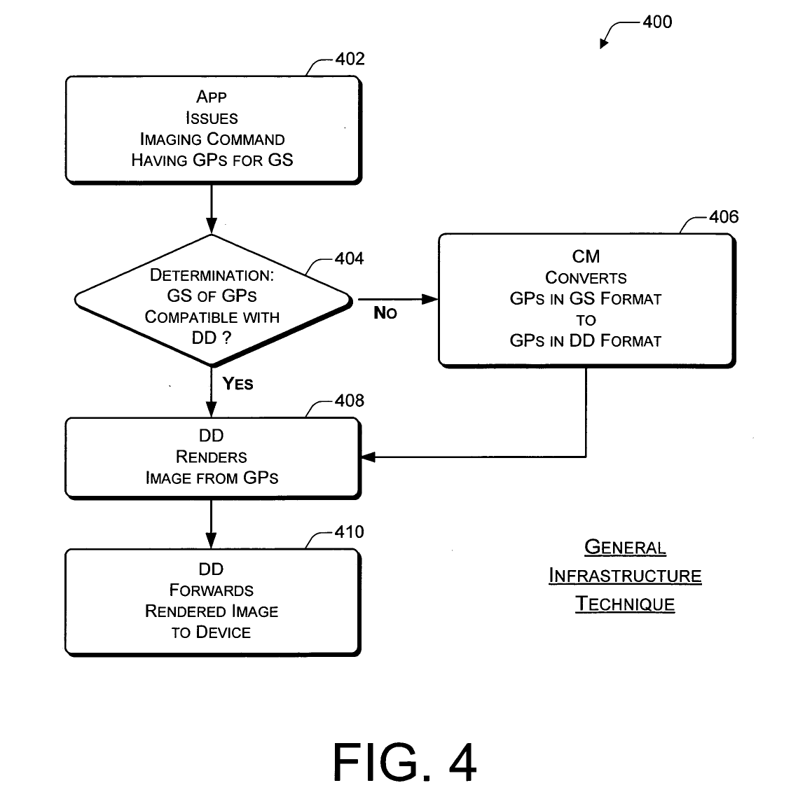

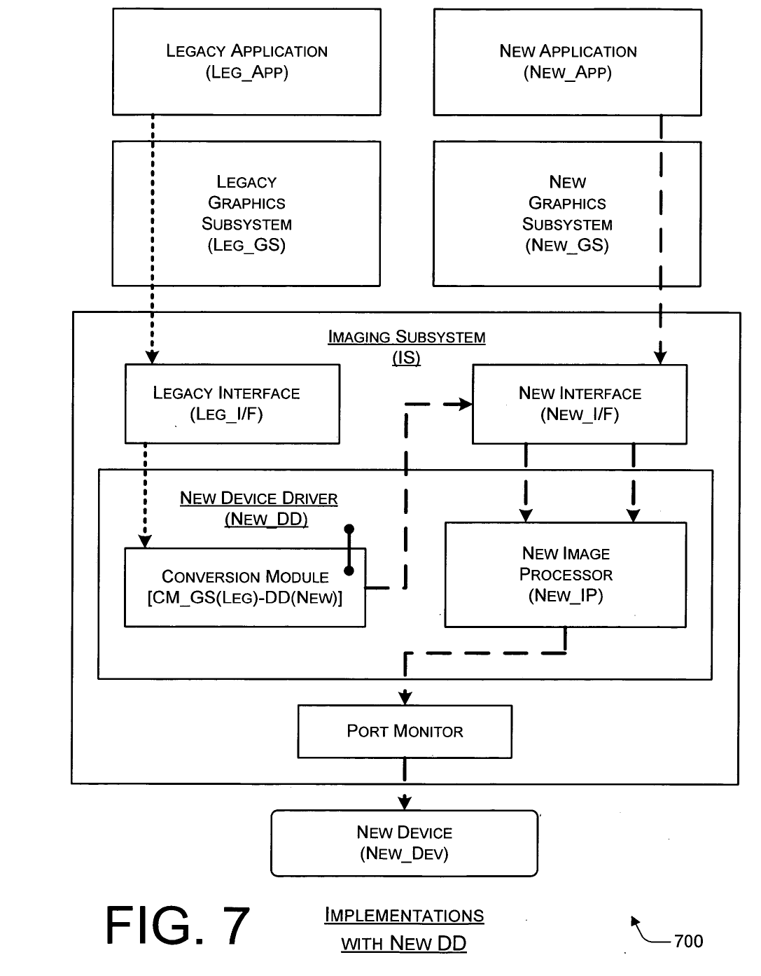

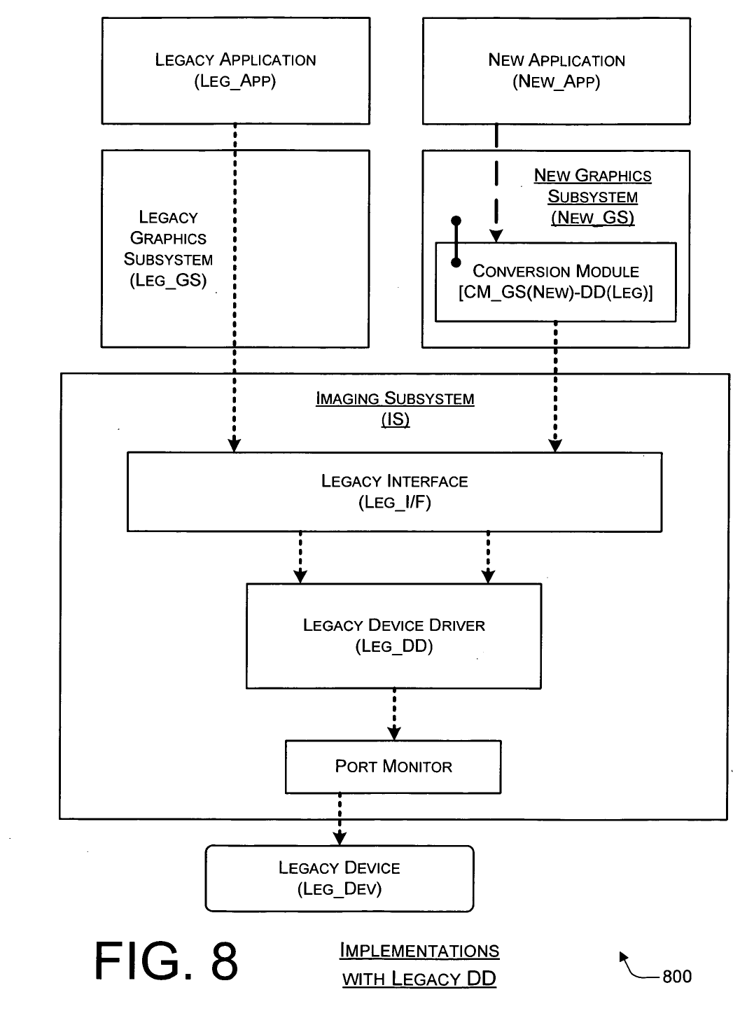

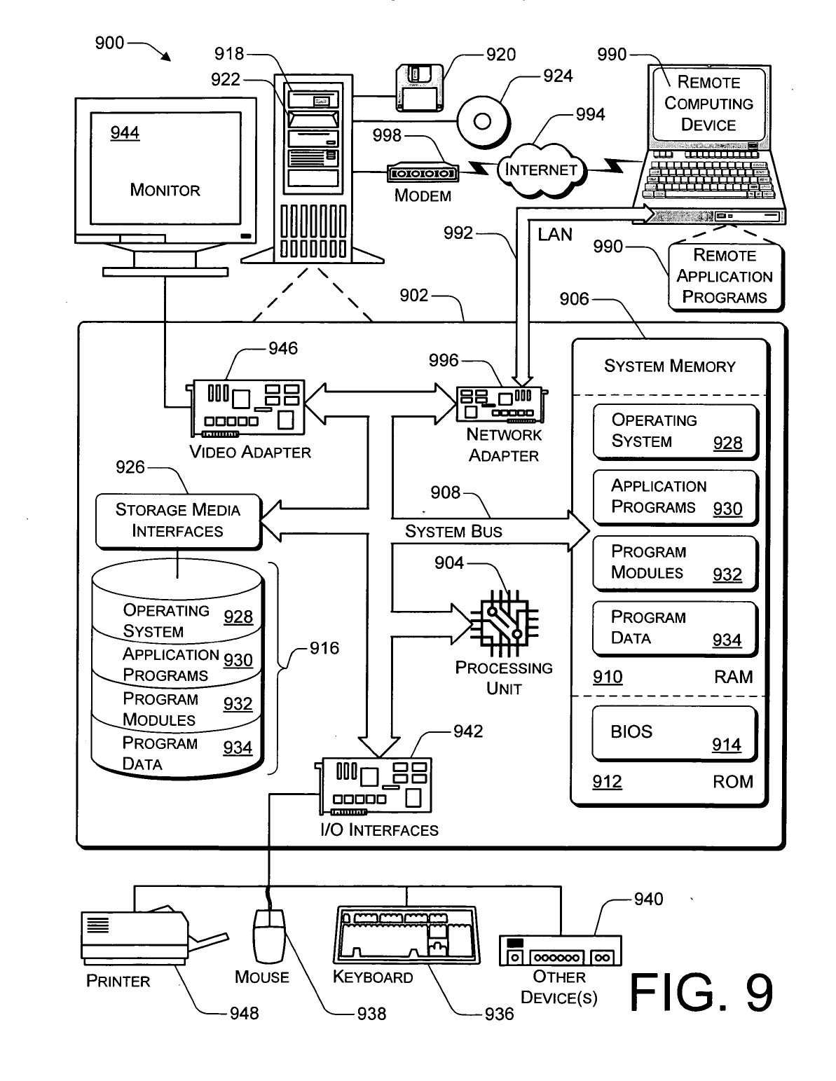

To facilitate understanding, this description is separated into four sections. A first section references FIGS. 1-3 and is entitled “General Example Mechanisms for Pre-Rendering Conversion”. A second section references FIGS. 4-6 and is entitled “General Example Techniques for Pre-Rendering Conversion”. A third section references FIGS. 7-8 and is entitled “Specific New/Legacy-Related Example Implementations for Pre-Rendering Conversion”. There is also a fourth section that references FIG. 9 and is entitled “Example Operating Environment for Computer or Other Device”.

### General Example Mechanisms for Pre-Rendering Conversion

FIG. 1 is a block diagram that illustrates an example image processing path 100 with a pre-rendering conversion capability. As shown, image processing path 100 includes an application (App), graphics primitives (GPs), a graphics subsystem (GS), infrastructure, a conversion module (CM), a device driver (DD), and a device.

In a described implementation, the illustrated graphics subsystem represents an application graphics model for realizing graphical primitives used by an application for rendering images. Typically, a graphics subsystem is a component of an operating system (OS) or a developer platform, but other realizations are possible. Thus, a graphics subsystem can present or provide multiple graphics primitives and expose them to applications as a set of APIs.

The illustrated application generates application-level graphics primitives targeted to a particular graphics subsystem. The graphics primitives are to be processed and/or rendered within image processing path 100. The application can thus command the graphics subsystem using the provided graphics primitives.

The illustrated device driver processes graphics-layer graphics primitives to produce rendering instructions for interpretation by a physical device (e.g., a monitor, a printer, etc.) that is connected to a computing system. The rendering functionality of the device driver is referred to herein as a rendering module (not explicitly illustrated). Typically, each device driver is associated with a device, and vice versa.

The illustrated device is capable of generating an image responsive to rendering instructions received from the device driver. An imaging device is generally capable of producing the rendered image in a relatively-temporary medium (such as with a monitor, a television, or another screen) or in a relatively-permanent medium (such as on paper or other hard copy output with a printer or equivalent device).

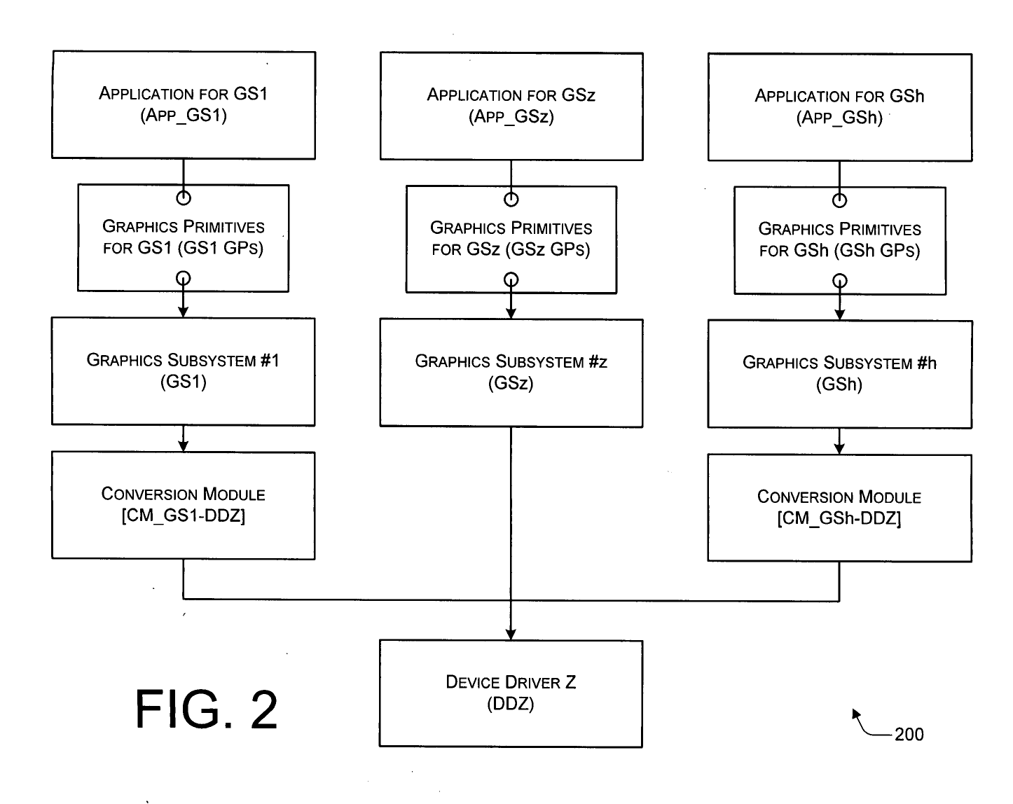

The illustrated conversion module generally represents a conversion between a graphics subsystem format and a device driver format interpretable by a rendering module of the device driver. If a device driver is capable of directly interpreting the graphics primitives of a particular graphics subsystem, then no conversion is performed on graphics primitives that target that particular graphics subsystem. The conversion module may be omitted from an image processing path 100, as is described further herein below with particular reference to FIG. 2.

The illustrated infrastructure comprises some computing system infrastructure that may be realized as hardware, software, firmware, some combination thereof, and so forth. For example, all or part of the infrastructure may comprise some portion of the graphics subsystem, the device driver, an operating system (OS), other system management and/or control component(s), an independent (e.g., dedicated) component, some combination thereof, and so forth.

The infrastructure is capable of detecting an incompatibility between the graphics primitives in a subsystem format for the graphics subsystem and a driver format appropriate for the device driver. Upon such a detection, the infrastructure is adapted to have the graphics primitives converted from one (e.g., first) format to another (e.g., second) format. For example, the infrastructure may cause or precipitate the conversion module to be applied to the original graphics primitives in the subsystem format to produce via a conversion converted graphics primitives in a driver format. The infrastructure and the conversion module effectively decouple the application from the device driver.

The infrastructure may be capable of automatically determining compatibility/incompatibility between the graphics subsystem targeted by graphics primitives and the device driver to which the graphics primitives are destined. The infrastructure is also adapted to automatically engage the conversion module upon determination of an incompatibility. Consequently, the infrastructure is capable of causing the conversion to occur transparently. In a described implementation, the detection and conversion transparency is with respect to at least the application and a user thereof. Depending on implementation, the transparency may also be with respect to the graphics subsystem and/or the device driver.

In an example operation, the application issues an imaging command having graphics primitives to the graphics subsystem. The infrastructure determines if the graphics primitives for the graphics subsystem match a format for the device driver. If they do match, the graphics primitives in the original format are forwarded to the device driver.

If, on the other hand, the graphics primitives in the original format are not determined to match a format corresponding to the device driver, the graphics primitives are supplied to the conversion module to precipitate a conversion. The conversion module converts the graphics primitives in the original subsystem format into graphics primitives in a converted driver format. These graphics primitives in the converted driver format are then forwarded to the device driver by the infrastructure and/or the conversion module.

Upon receipt of the graphics primitives in a compatible format, the device driver interprets the graphics primitives to render them into an image as intended by the application. The rendered imaging instructions are forwarded from the device driver to the imaging device for production of an image in accordance therewith.

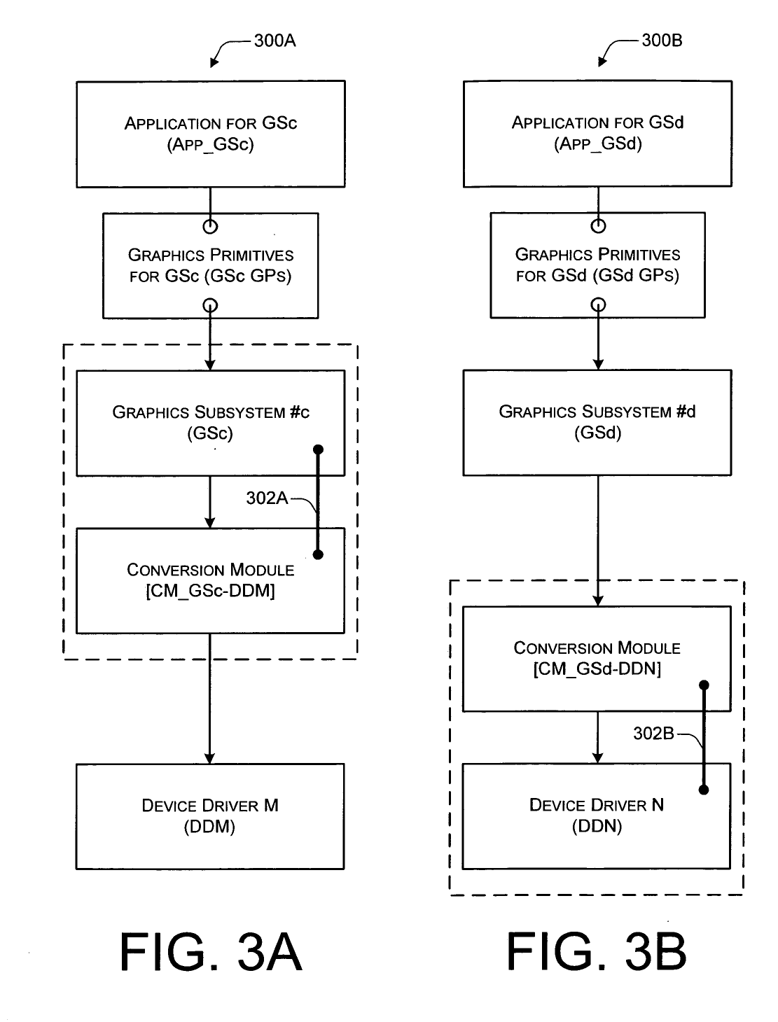

Image processing path 100 may be operated in any of many possible alternative manners. For example, the infrastructure and/or conversion module may be independent of the graphics subsystem and/or the device driver. Alternatively, the infrastructure and/or conversion module may be fully or partially incorporated into the graphics subsystem. An example of this implementation is described further herein below with particular reference to FIG. 3A. Also, the infrastructure and/or conversion module may be fully or partially incorporated into the device driver. An example of this implementation is described further herein below with particular reference to FIG. 3B.

FIG. 2 is a block diagram that illustrates an example of multiple image processing paths 200 that can utilize a single device driver (DD), with each image processing path having a different graphics subsystem (GS). As illustrated, there are three image processing paths. However, more or fewer than three image processing paths may alternatively be implemented within a given computing system.

Generally, each image processing path includes an application (App) for a given graphics subsystem, a graphics subsystem (GS) that presents graphics primitives (GPs) targeted there for, and a device driver Z (DDZ). Two image processing paths also include a conversion module (CM) for converting graphics primitives in a first format into graphics primitives in a second format.

In the context of image processing paths 200 of FIG. 2, a particular instantiation of a graphics subsystem #x is abbreviated or termed: GSx where x=1, 2, . . . , h (x including “z”). A particular instantiation of an application for a specific graphics subsystem x is abbreviated or termed: App_GSx. A particular instantiation of a device driver is abbreviated or termed: DDY where Y=1, 2, . . . , I (Y including “Z”). A particular instantiation of a conversion module for a specific graphics subsystem #x (GSx) to a specific device driver Y (DDY) is abbreviated or termed: CM_GSx-DDY.

Each of the image processing paths 200 includes the same device driver Z (DDZ). Of the three image processing paths 200, the left image processing path includes an application for GS1 (App_GS1) and a graphics subsystem #1 (GS1). Graphics subsystem #1 (GS1) presents or defines graphics primitives for GS1 (GS1 GPs) for use by application for GS1 (App_GS1). The left image processing path also includes a conversion module [CM_GS1-DDZ].

The right image processing path includes an application for GSh (App_GSh) and a graphics subsystem #h (GSh). Graphics subsystem #h (GSh) defines graphics primitives for GSh (GSh GPs) for use by application for GSh (App_GSh). The right image processing path also includes a conversion module [CM_GSh-DDZ].

The middle or center image processing path includes an application for GSz (App_GSz) and a graphics subsystem #z (GSz). Graphics subsystem #z (GSz) defines graphics primitives for GSz (GSz GPs) for use by application for GSz (App_GSz). The middle image processing path does not include a conversion module.

For the left image processing path, the conversion module [CM_GS1-DDZ] is capable of converting graphics primitives for GS1 (GS1 GPs) into graphics primitives of a format that is compatible with device driver Z (DDZ). For example, conversion module [CM_GS1-DDZ] may convert graphics primitives for GS1 (GS1 GPs) into a format that is equivalent to that of graphics primitives for GSz (GSz GPs). For the right image processing path, the conversion module [CM_GSh-DDZ] is capable of converting graphics primitives for GSh (GSh GPs) into graphics primitives in a format that is compatible with device driver Z (DDZ). The middle image processing path does not include a conversion module because the graphics primitives for GSz (GSz GPs) are already compatible with device driver Z (DDZ).

As described herein above, conventional approaches usually entail a one-to-one correspondence between graphics subsystems and corresponding device drivers (at least per Printer Description Language (PDL) in a printing environment). In contrast, with the approach described herein with particular reference to FIG. 2, multiple graphics subsystems (GSs) (and the graphics layers thereof) may be utilized in conjunction with as few as a single device driver (DD). Hence, although only one graphics subsystem (GS) (i.e., GSz) is intrinsically compatible with the device driver (DDZ), all three image processing paths 200 function with device driver (DDZ) via at least one conversion module (e.g., conversion module [CM_GS1-DDZ] and conversion module [CM_GSh-DDZ]).

Certain approaches described herein also enable two parallel imaging paths (e.g., printing or displaying paths) to be established within a single computing system. Any benefits provided by a first path but not a second path may be offered to and/or utilized by the second path in a transparent manner with the insertion of a converting shunt (e.g., a conversion module) somewhere along the second imaging path that redirects processing toward the first path. Moreover, there may be two unique sources of graphics primitives and drivers, but at least one conversion module enables their features to be accessed with greater flexibility.

In other words, certain approaches as described herein preserve the ability to have isolated applications and device drivers while at least one conversion module enables a sharing or cross-pollination of features between the otherwise isolated applications and device drivers. From another perspective, the infrastructure (as explicitly shown in FIG. 1) and at least one conversion module enable applications that are built on/designed for various graphics subsystems to automatically communicate with (e.g., print or display using) device drivers that are authored for different graphics subsystems.

FIGS. 3A and 3B are example block diagrams illustrating a conversion module being associated with a graphics subsystem and with a device driver, respectively. Each of the block diagrams represents an image processing path 300A/B. An association that involves a conversion module is indicated by 302A/B in each of paths 300A/B.

As shown, each image processing path 300 includes an application designed for a GSx (App_GSx), a graphics subsystem #x (GSx) that defines graphics primitives for GSx (GSx GPs), a conversion module [CM_GSx-DDY], and a device driver Y (DDY). For image processing path 300A of FIG. 3A, the variable “x” equates to “c”, and the variable “Y” equates to “M”. For image processing path 300B of FIG. 3B, the variable “x” equates to “d”, and the variable “Y” equates to “N”.

As indicated by association indicator 302A, conversion module [CM_GSc-DDM] is associated with graphics subsystem #c (GSc). Hence, in image processing path 300A, the compatibility determination and the conversion may be effectuated by graphics subsystem #c (GSc), especially if conversion module [CM_GSc-DDM] is part of graphics subsystem #c (GSc). With image processing path 300A, the association 302A of conversion module [CM_GSc-DDM] with graphics subsystem #c (GSc) enables the conversion module to be accessible to essentially all device drivers of type “M” on the system.

As indicated by association indicator 302B, conversion module [CM_GSd-DDN] is associated with device driver N (DDN). Hence, in image processing path 300B, the compatibility determination and the conversion may be effectuated by device driver N (DDN), especially if conversion module [CM_GSd-DDN] is part of device driver N (DDN). With image processing path 300B, the association 302B of conversion module [CM_GSd-DDN] with device driver N (DDN) enables the conversion module to be distributed with the device driver so that it can be present on any computing system that is compatible with the device driver.

Thus, by way of example only, conversion modules may be associated with graphics subsystems or device drivers, depending on the implementation. If a conversion module is associated with a graphics subsystem, the conversion occurs before graphics primitives are processed by a device driver, and the conversion module is not usually transferred or installed with the device driver. If a conversion module is associated with a device driver, the conversion occurs within the device driver package, and the conversion module is usually transferred and installed with the device driver.

### General Example Techniques for Pre-Rendering Conversion

FIG. 4 is a flow diagram 400 that illustrates an example of a method for a determination, by general computing infrastructure, if a conversion module is to be applied within an image processing path. Flow diagram 400 includes five (5) blocks 402-410. Although the actions of flow diagram 400 may be performed in other environments and with a variety of hardware and software combinations, FIGS. 1-3 are used in particular to illustrate certain aspects and examples of the method.

At block 402, an application issues an imaging command having graphics primitives that target a given graphics subsystem. The imaging command is destined for a particular device driver. At block 404, a determination is made by general computing system infrastructure as to if the graphics subsystem targeted by the graphics primitives is compatible with the destination device driver. If so, then the method of flow diagram 400 continues at block 408.

If, on the other hand, it is determined by the infrastructure that the graphics subsystem targeted by the graphics primitives is not compatible with the destination device driver (at block 404), then at block 406 a conversion module converts the graphics primitives in the graphics subsystem format to graphics primitives in the device driver format. Afterwards, the method of flow diagram 400 continues at block 408.

At block 408, the device driver renders an image in accordance with the graphics primitives. The graphics primitives may be in an original format as included with the imaging command issued by the application or in a converted format that results from the action(s) of block 406. Regardless, the format of the graphics primitives as rendered by a rendering module of the device driver is a format that is compatible with the device driver.

At block 410, the device driver forwards the rendered image to a device. After receiving image rendering instructions from the device driver, an imaging device may produce the rendered image.

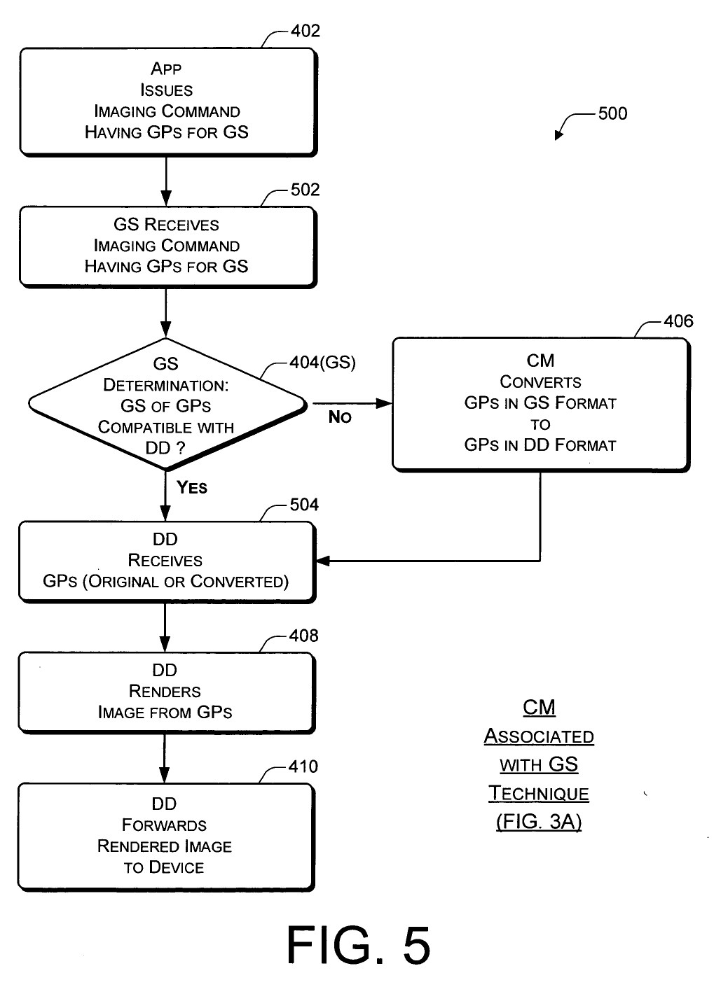

FIG. 5 is a flow diagram 500 that illustrates an example of a method for a determination, by a graphics subsystem, if a conversion module is to be applied within an image processing path that includes the graphics subsystem. With the general method of flow diagram 400, any computing system infrastructure may perform the action(s) of block 404. In contrast, the graphics subsystem specifically performs the action(s) of block 404(GS) in the method of flow diagram 500.

Hence, the actions of flow diagram 500 can correspond to an implementation in which the conversion module is associated with the graphics subsystem, as described herein above with particular reference to FIG. 3A. In comparison to flow diagram 400, flow diagram 500 adds blocks 502 and 504.

At block 402, an application issues an imaging command having graphics primitives that target a given graphics subsystem. The imaging command is destined for a particular device driver. At block 502, the targeted graphics subsystem receives the imaging command having the graphics primitives targeting the graphics subsystem.

At block 404(GS), a determination is made by the targeted graphics subsystem as to if the graphics subsystem targeted by the graphics primitives is compatible with the destination device driver. If so, then the method of flow diagram 500 continues at block 504.

If, on the other hand, it is determined by the graphics subsystem that the graphics subsystem targeted by the graphics primitives is not compatible with the destination device driver (at block 404(GS)), then at block 406 a conversion module converts the graphics primitives in the graphics subsystem format to graphics primitives in the device driver format. Afterwards, the method of flow diagram 500 continues at block 504.

At block 504, the destination device driver receives the graphics primitives, which may be in an original format or in a converted format. If the conversion was not performed, the graphics primitives may be received in the original format from the graphics subsystem. If the conversion was performed (at block 406), the graphics primitives may be received in the converted format from the conversion module.

At block 408, the device driver renders an image in accordance with the graphics primitives. As described above, the graphics primitives may be in the original format as they existed with the imaging command issued by the application or in a converted format that results from the action(s) of block 406. Regardless, the format of the graphics primitives as rendered at block 408 by a rendering module of the device driver is a format that is compatible with the device driver.

At block 410, the device driver forwards the rendered image to a device. After receiving image rendering instructions from the device driver, an imaging device may produce the rendered image.

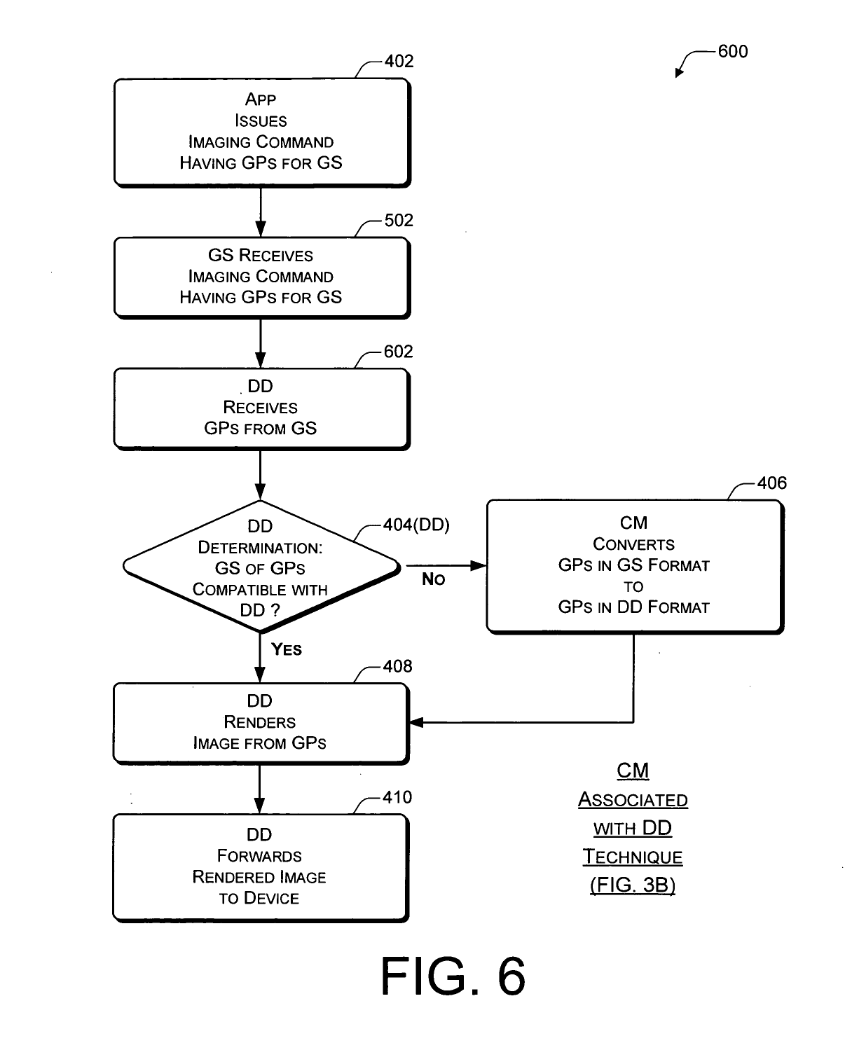

FIG. 6 is a flow diagram 600 that illustrates an example of a method for a determination, by a device driver, if a conversion module is to be applied within an image processing path that includes the device driver. In contrast to the general method of flow diagram 400 and the other specific method of flow diagram 500, the device driver specifically performs the action(s) of block 404(DD) in the method of flow diagram 600.

Hence, the actions of flow diagram 600 can correspond to an implementation in which the conversion module is associated with the device driver, as described herein above with particular reference to FIG. 3B. In comparison to flow diagram 400, flow diagram 600 adds blocks 502 and 602.

At block 402, an application issues an imaging command having graphics primitives that target a given graphics subsystem. The imaging command is destined for a particular device driver.

At block 502, the targeted graphics subsystem receives the imaging command having the graphics primitives targeting the graphics subsystem. At block 602, the destination device driver receives the graphics primitives from the targeted graphics subsystem.

At block 404(DD), a determination is made by the destination device driver as to if the graphics subsystem targeted by the graphics primitives is compatible with the destination device driver. If so, then the method of flow diagram 600 continues at block 408.

If, on the other hand, it is determined by the destination device driver that the graphics subsystem targeted by the graphics primitives is not compatible with the device driver (at block 404(DD)), then at block 406 a conversion module converts the graphics primitives in the graphics subsystem format to graphics primitives in the device driver format. Afterwards, the method of flow diagram 600 continues at block 408.

At block 408, the device driver renders an image in accordance with the graphics primitives. The graphics primitives may be (i) in an original format as received from the graphics subsystem (at block 602) or (ii) in a converted format that results from the action(s) of block 406 and as possibly received from the conversion module. Regardless, the format of the graphics primitives as rendered by a rendering module of the device driver is a format that is compatible with the device driver.

At block 410, the device driver forwards the rendered image to a device. After receiving rendered image instructions from the device driver, an imaging device may produce the rendered image.

### Specific New/Legacy-Related Example Implementations for Pre-Rendering Conversion

Pre-rendering conversion of graphical data as described herein may be utilized in a myriad of situations and environments. One example situation is facilitating a transition from a legacy graphics environment to a new graphics environment. For example, a conversion module may be inserted in an image processing path that includes (i) a legacy application and a legacy graphics subsystem and (ii) a new device driver and a new imaging subsystem. An example of this implementation is described further herein below with particular reference to FIG. 7.

Also, a conversion module may be inserted in an image processing path that includes (i) a new application and a new graphics subsystem and (ii) a legacy device driver and a legacy imaging subsystem. An example of this implementation is described further herein below with particular reference to FIG. 8. Although illustrated and described separately, the two environments of FIGS. 7 and 8 may be simultaneously implemented within one computing system.

FIG. 7 is a block diagram 700 of an example implementation of pre-rendering conversion when employing a new device driver with a legacy application or a new application. As illustrated, block diagram 700 includes a legacy application (Leg_App), a new application (New_App), a legacy graphics subsystem (Leg_GS), a new graphics subsystem (New_GS), an imaging subsystem (IS), and a new device (New_Dev). The imaging subsystem includes a legacy interface (Leg_I/F), a new interface (New_I/F), a new device driver (New DD), and a port monitor.

In a described implementation, the new device driver includes a conversion module [CM_GS(Leg)-DD(New)] and a new image processor (New_IP). The conversion module [CM_GS(Leg)-DD(New)] is associated with the new device driver. The new device driver is capable of detecting when graphics primitives targeting the legacy graphics subsystem are received and are incompatible with the new device driver. When such a detection is made, the new device driver engages the conversion module [CM_GS(Leg)-DD(New)].

The conversion module [CM_GS(Leg)-DD(New)] is adapted to convert graphics primitives in a first format targeting a legacy graphics subsystem into graphics primitives in a second format appropriate for the new device driver. After the format conversion of the graphics primitives, the new device driver by virtue of the new image processor is capable of rendering an image defined by the graphics primitives in the new format.

In FIG. 7, the short dashed lines represent a legacy imaging path, and the long dashed lines represent a new imaging path. The legacy imaging path starts at the legacy application, which sends an imaging command having graphics primitives in the legacy format to the legacy interface of the imaging subsystem via the legacy graphics subsystem, which may perform some partial rendering. The graphics primitives in the legacy format are forwarded from the legacy interface to the new device driver.

The new device driver detects the format incompatibility of the graphics primitives with respect to the new image processor portion of the new device driver. Consequently, the new device driver submits the graphics primitives in the legacy format to the conversion module [CM_GS(Leg)-DD(New)]. The conversion module [CM_GS(Leg)-DD(New)] converts the graphics primitives in the legacy format to graphics primitives in the new format, which transforms the continued path into a new imaging path.

The new image processor of the new device driver processes the graphics primitives in the new format to produce rendering instructions for the image defined by the graphics primitives. The rendering instructions are also routed through the new interface of the imaging subsystem and thence to the new image processor. From the new image processor, the rendering instructions may be appropriately sent to the new device via the port monitor.

The new imaging path starts at the new application, which sends an imaging command having graphics primitives in the new format to the new interface via the new graphics subsystem, which may perform some partial rendering. The graphics primitives in the new format are then sent from the new interface to the new image processor of the new device driver. From the new image processor, the rendering instructions may be appropriately sent to the new device via the port monitor.

FIG. 8 is a block diagram 800 of an example implementation of pre-rendering conversion when employing a legacy device driver with a legacy application or a new application. As illustrated, block diagram 800 includes a legacy application (Leg_App), a new application (New_App), a legacy graphics subsystem (Leg_GS), a new graphics subsystem (New_GS), an imaging subsystem (IS), and a legacy device (Leg_Dev). The imaging subsystem includes a legacy interface (Leg_I/F), a legacy device driver (Leg_DD), and a port monitor.

In a described implementation, the new graphics subsystem includes a conversion module [CM_GS(New)-DD(Leg)]. The conversion module [CM_GS(New)-DD(Leg)] is associated with the new graphics subsystem. The new graphics subsystem is capable of detecting when graphics primitives targeting a new graphics subsystem are received and are incompatible with the destination legacy device driver. When such a detection is made, the graphics subsystem engages the conversion module [CM_GS(New)-DD(Leg)].

The conversion module [CM_GS(New)-DD(Leg)] is adapted to convert graphics primitives in a first format targeting the new graphics subsystem into graphics primitives in a second format appropriate for the legacy device driver. After the format conversion of the graphics primitives, the legacy device driver is capable of rendering an image defined by the graphics primitives in the legacy format.

In FIG. 8, the short dashed lines represent a legacy imaging path, and the long dashed lines represent a new imaging path. The legacy imaging path starts at the legacy application, which sends an imaging command having graphics primitives in the legacy format to the legacy interface of the imaging subsystem via the legacy graphics subsystem, which may perform some partial rendering. The graphics primitives in the legacy format are forwarded from the legacy interface to the legacy device driver.

The legacy device driver is adapted to process the legacy graphics primitives in the legacy format to produce image rendering instructions. After doing so, the legacy device driver may appropriately send the image rendering instructions to the legacy device via the port monitor.

The new imaging path starts at the new application, which sends an imaging command having graphics primitives in the new format to the new graphics subsystem. The new graphics subsystem detects the format incompatibility of the graphics primitives with respect to the rendering module (not explicitly shown) portion of the legacy device driver. Consequently, the new graphics subsystem submits the graphics primitives in the new format to the conversion module [CM_GS(New)-DD(Leg)]. The conversion module [CM_GS(New)-DD(Leg)] converts the graphics primitives in the new format to graphics primitives in the legacy format, which transforms the continued path into a legacy imaging path.

The converted graphics primitives in the legacy format are then forwarded to the legacy interface of the imaging subsystem. From the legacy interface, the graphics primitives in the legacy format are forwarded to the legacy device driver.

The legacy device driver processes the graphics primitives in the legacy format to produce rendering instructions for the image defined by the graphics primitives. After doing so, the legacy device driver may appropriately send the image rendering instructions to the legacy device via the port monitor.

The systems, devices, actions, aspects, features, functions, procedures, modules, data structures, components, etc. of FIGS. 1-8 are illustrated in diagrams that are divided into multiple blocks. However, the order, interconnections, interrelationships, layout, etc. in which FIGS. 1-8 are described and/or shown is not intended to be construed as a limitation, and any number of the blocks can be modified, combined, rearranged, augmented, omitted, etc. in any manner to implement one or more systems, methods, devices, procedures, media, apparatuses, APIs, arrangements, etc. for pre-rendering conversion. Furthermore, although the description herein includes references to specific implementations (including a general device of FIG. 9), the illustrated and/or described implementations can be implemented in any suitable hardware, software, firmware, or combination thereof and using any image processing path organization(s), conversion module association(s), conversion algorithm(s), graphics primitives format(s), and/or infrastructure realization(s), and so forth.

### Example Operating Environment for Computer or Other Device

FIG. 9 illustrates an example computing (or general device) operating environment 900 that is capable of (fully or partially) implementing at least one system, device, apparatus, component, arrangement, protocol, approach, method, procedure, media, API, some combination thereof, etc. for pre-rendering conversion as described herein. Operating environment 900 may be utilized in the computer and network architectures described below.

Example operating environment 900 is only one example of an environment and is not intended to suggest any limitation as to the scope of use or functionality of the applicable device (including computer, network node, entertainment device, mobile appliance, general electronic device, etc.) architectures. Neither should operating environment 900 (or the devices thereof) be interpreted as having any dependency or requirement relating to any one or to any combination of components as illustrated in FIG. 9.

Additionally, implementations for pre-rendering conversion may be realized with numerous other general purpose or special purpose device (including computing system) environments or configurations. Examples of well known devices, systems, environments, and/or configurations that may be suitable for use include, but are not limited to, personal computers, server computers, thin clients, thick clients, personal digital assistants (PDAs) or mobile telephones, watches, hand-held or laptop devices, multiprocessor systems, microprocessor-based systems, set-top boxes, programmable consumer electronics, video game machines, game consoles, portable or handheld gaming units, network PCs, videoconferencing equipment, minicomputers, mainframe computers, network nodes, distributed or multi-processing computing environments that include any of the above systems or devices, some combination thereof, and so forth.

Implementations for pre-rendering conversion may be described in the general context of processor-executable instructions. Generally, processor-executable instructions include routines, programs, protocols, objects, functions, interfaces, components, data structures, etc. that perform and/or enable particular tasks and/or implement particular abstract data types. Realizations of pre-rendering conversion pre-rendering conversion, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

Example operating environment 900 includes a general-purpose computing device in the form of a computer 902, which may comprise any (e.g., electronic) device with computing/processing capabilities. The components of computer 902 may include, but are not limited to, one or more processors or processing units 904, a system memory 906, and a system bus 908 that couples various system components including processor 904 to system memory 906.

Processors 904 are not limited by the materials from which they are formed or the processing mechanisms employed therein. For example, processors 904 may be comprised of semiconductor(s) and/or transistors (e.g., electronic integrated circuits (ICs)). In such a context, processor-executable instructions may be electronically-executable instructions. Alternatively, the mechanisms of or for processors 904, and thus of or for computer 902, may include, but are not limited to, quantum computing, optical computing, mechanical computing (e.g., using nanotechnology), and so forth.

System bus 908 represents one or more of any of many types of wired or wireless bus structures, including a memory bus or memory controller, a point-to-point connection, a switching fabric, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, some combination thereof, and so forth.

Computer 902 typically includes a variety of processor-accessible media. Such media may be any available media that is accessible by computer 902 or another (e.g., electronic) device, and it includes both volatile and non-volatile media, removable and non-removable media, and storage and transmission media.

System memory 906 includes processor-accessible storage media in the form of volatile memory, such as random access memory (RAM) 910, and/or non-volatile memory, such as read only memory (ROM) 912. A basic input/output system (BIOS) 914, containing the basic routines that help to transfer information between elements within computer 902, such as during start-up, is typically stored in ROM 912. RAM 910 typically contains data and/or program modules/instructions that are immediately accessible to and/or being presently operated on by processing unit 904.

Computer 902 may also include other removable/non-removable and/or volatile/non-volatile storage media. By way of example, FIG. 9 illustrates a hard disk drive or disk drive array 916 for reading from and writing to a (typically) non-removable, non-volatile magnetic media (not separately shown); a magnetic disk drive 918 for reading from and writing to a (typically) removable, non-volatile magnetic disk 920 (e.g., a “floppy disk”); and an optical disk drive 922 for reading from and/or writing to a (typically) removable, non-volatile optical disk 924 such as a CD, DVD, or other optical media. Hard disk drive 916, magnetic disk drive 918, and optical disk drive 922 are each connected to system bus 908 by one or more storage media interfaces 926. Alternatively, hard disk drive 916, magnetic disk drive 918, and optical disk drive 922 may be connected to system bus 908 by one or more other separate or combined interfaces (not shown).

The disk drives and their associated processor-accessible media provide non-volatile storage of processor-executable instructions, such as data structures, program modules, and other data for computer 902. Although example computer 902 illustrates a hard disk 916, a removable magnetic disk 920, and a removable optical disk 924, it is to be appreciated that other types of processor-accessible media may store instructions that are accessible by a device, such as magnetic cassettes or other magnetic storage devices, flash memory, compact disks (CDs), digital versatile disks (DVDs) or other optical storage, RAM, ROM, electrically-erasable programmable read-only memories (EEPROM), and so forth. Such media may also include so-called special purpose or hard-wired IC chips. In other words, any processor-accessible media may be utilized to realize the storage media of the example operating environment 900.

Any number of program modules (or other units or sets of processor-executable instructions) may be stored on hard disk 916, magnetic disk 920, optical disk 924, ROM 912, and/or RAM 910, including by way of general example, an operating system 928, one or more application programs 930, other program modules 932, and program data 934. These processor-executable instructions may include, for example, one or more of: an application (App), graphics primitives (GPs), a graphics subsystem (GS), a conversion module (CM), a device driver (DD), computing system infrastructure, some combination thereof, and so forth.

A user may enter commands and/or information into computer 902 via input devices such as a keyboard 936 and a pointing device 938 (e.g., a “mouse”). Other input devices 940 (not shown specifically) may include a microphone, joystick, game pad, satellite dish, serial port, video camera, scanner, and/or the like. These and other input devices are connected to processing unit 904 via input/output interfaces 942 that are coupled to system bus 908. However, input devices and/or output devices may instead be connected by other interface and bus structures, such as a parallel port, a game port, a universal serial bus (USB) port, an infrared port, an IEEE 1394 (“Firewire”) interface, an IEEE 802.11 wireless interface, a Bluetooth® wireless interface, and so forth.

A monitor/view screen 944 or other type of display device may also be connected to system bus 908 via an interface, such as a video adapter 946. Video adapter 946 (or another component) may be or may include a graphics card for processing graphics-intensive calculations and for handling demanding display requirements. Typically, a graphics card includes a graphics processing unit (GPU), video RAM (VRAM), etc. to facilitate the expeditious display of graphics and performance of graphics operations. In addition to monitor 944, other output peripheral devices may include components such as speakers (not shown) and a printer 948, which may be connected to computer 902 via input/output interfaces 942.

Computer 902 may operate in a networked environment using logical connections to one or more remote computers, such as a remote computing device 950. By way of example, remote computing device 950 may be a peripheral device, a personal computer, a portable computer (e.g., laptop computer, tablet computer, PDA, mobile station, etc.), a palm or pocket-sized computer, a watch, a gaming device, a server, a router, a network computer, a peer device, another network node, or another device type as listed above, and so forth. However, remote computing device 950 is illustrated as a portable computer that may include many or all of the elements and features described herein with respect to computer 902.

Logical connections between computer 902 and remote computer 950 are depicted as a local area network (LAN) 952 and a general wide area network (WAN) 954. Such networking environments are commonplace in offices, enterprise-wide computer networks, intranets, the Internet, fixed and mobile telephone networks, ad-hoc and infrastructure wireless networks, mesh networks, other wireless networks, gaming networks, some combination thereof, and so forth. Such networks and logical and physical communications connections are additional examples of transmission media.

When implemented in a LAN networking environment, computer 902 is usually connected to LAN 952 via a network interface or adapter 956. When implemented in a WAN networking environment, computer 902 typically includes a modem 958 or other component for establishing communications over WAN 954. Modem 958, which may be internal or external to computer 902, may be connected to system bus 908 via input/output interfaces 942 or any other appropriate mechanism(s). It is to be appreciated that the illustrated network connections are examples and that other manners for establishing communication link(s) between computers 902 and 950 may be employed.

In a networked environment, such as that illustrated with operating environment 900, program modules or other instructions that are depicted relative to computer 902, or portions thereof, may be fully or partially stored in a remote media storage device. By way of example, remote application programs 960 reside on a memory component of remote computer 950 but may be usable or otherwise accessible via computer 902. Also, for purposes of illustration, application programs 930 and other processor-executable instructions such as operating system 928 are illustrated herein as discrete blocks, but it is recognized that such programs, components, and other instructions reside at various times in different storage components of computing device 902 (and/or remote computing device 950) and are executed by processor(s) 904 of computer 902 (and/or those of remote computing device 950).

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features of diagrams described. Rather, the specific features and diagrams are disclosed as exemplary forms of implementing the claimed invention.

What is claimed is:

1. A method comprising:
determining if a graphics subsystem targeted by one or more graphics primitives is compatible with a destination device driver; and
if the graphics subsystem targeted by the one or more graphics primitives is determined to not compatible with the destination device driver, converting the one or more graphics into a format that is compatible with the destination device driver.

2. The method as recited in claim 1, wherein:
the determining is preformed by general infrastructure of a computing system; and
the converting is performed by at least one conversion module present in the computing system.

3. The method as recited in claim 1, wherein:
the determining is performed by the graphics subsystem targeted by the one or more graphics primitives; and
the converting is performed by at least one conversion module that is associated with the graphics subsystem targeted by the one or more graphics primitives.

4. The method as recited in claim 1, wherein:
the determining is performed by the destination device driver; and
the converting is performed by at least one conversion module that is associated with the destination device driver.

5. The method as recited in claim 1, further comprising:
issuing, by an application, at least one imaging command having the one or more graphics primitives that target the graphics subsystem.

6. The method as recited in claim 1, further comprising:
rendering, by the destination device driver, at least part of an image defined by the one or more graphics primitives;
wherein the converting, if it is performed, occurs prior to the rendering.

7. One or more processor-accessible media including processor-executable instructions comprising a graphics subsystem that is capable of accepting from an application an imaging command having one or more graphics primitives in an original format; the graphics subsystem adapted to determine if the original format is compatible with a destination device driver; the graphics subsystem further adapted to cause the one or more graphics primitives to be converted to a converted format that is compatible with the destination device driver if the original format is determined to be incompatible with the destination device driver.

8. The one or more processor-accessible media as recited in claim 7, wherein the one or more graphics primitives comprise at least part of a set of graphics primitives that are provided by the graphics subsystem as an exposed graphics-oriented application programming interface (API) surface.

9. The one or more processor-accessible media as recited in claim 7, further comprising a conversion module that is associated with the graphics subsystem, the conversion module adapted to convert graphics primitives in the original format to graphics primitives in the converted format.

10. The one or more processor-accessible media as recited in claim 7, wherein the graphics subsystem is adapted to forward toward the destination device driver the one or more graphics primitives in the original format if the original format is compatible with the destination device driver and to forward toward the destination device driver the one or more graphics primitives in the converted format if the original format is determined to be incompatible with the destination device driver.

11. The one or more processor-accessible media as recited in claim 7, further comprising the destination device driver; wherein the destination device driver includes a rendering module that is capable of rendering an image in accordance with the imaging command based on the one or more graphics primitives in the converted format.

12. A computing system comprising:
a graphics subsystem that provides a set of graphics primitives in a graphics subsystem format;
a device driver that is capable of interpreting graphics primitives in a driver format;
a conversion module that is capable of converting one or more graphics primitives in a first format into one or more graphics primitives in a second format; and
computing infrastructure that is capable of detecting if the graphics subsystem format is compatible with the driver format; wherein if an incompatibility is detected, the computing infrastructure is adapted to apply the conversion module to graphics primitives in the graphics subsystem format to convert them into graphics primitives in the driver format.

13. The computing system as recited in claim 12, further comprising:
an application that is adapted to issue imaging commands to the graphics subsystem, the imaging commands including one or more graphics primitives in the graphics subsystem format.

14. The computing system as recited in claim 13, wherein the computing infrastructure operates automatically such that the detection and conversion, if any, is effectuated transparently with respect to at least the application.

15. The comprising system as recited in claim 12, wherein the device driver includes a rendering module that operates after the conversion module is applied to the graphics primitives to convert them into graphics primitives in the driver format.

16. The computing system as recited in claim 12, wherein the conversion module is associated at least a graphics subsystem; and wherein the computing infrastructure comprises at least a portion of the graphics subsystem.

17. The computing system as recited in claim 12, wherein the conversion module is associated with the device driver; and wherein the computing infrastructure comprises at least a portion of the device driver.

18. The computing system as recited in claim 12, further comprising:
another graphics subsystem that provides another set of graphics primitives in another graphics subsystem format;
another conversion module that is capable of converting one or more graphics primitives in a third format into one or more graphics primitives in a fourth format; and
additional computing infrastructure that is capable of detecting if the other graphics subsystem format is compatible with the driver format; wherein if another incompatibility is detected, the additional computing infrastructure is adapted to apply the other conversion module to graphics primitives in the other graphics subsystem format to convert them into graphics primitives in the driver format.

19. The computing system as recited in claim 12, further comprising:
a legacy application that is adapted to issue imaging commands to the graphics subsystem, the imaging commands including one or more graphics primitives in a legacy format;
wherein the device driver comprises a new device driver that includes the conversion module; and wherein the first format comprises the legacy format, and the second format comprises a new format that is compatible with the new device driver.

20. The computing system as recited in claim 12, further comprising:
a new application that is adapted to issue imaging commands to the graphics subsystem, the imaging commands including one or more graphics primitives in a new format;
wherein the graphics subsystem includes the conversion module, and the device driver comprises a legacy device driver; and wherein the first format comprises the new format, and the second format comprises a legacy format that is compatible with the legacy device driver.
